(19) United States
(12) Patent Application Publication
(10) Pub. No.: US 2019/0105214 A1
(43) Pub. Date: Apr. 11, 2019

(54) SUPPORT DEVICE AND METHOD OF OPERATING THE SUPPORT DEVICE

(71) Applicant: SIMPLANA GMBH, Aachen (DE)

(72) Inventor: Volker Perlitz, Aachen (DE)

(21) Appl. No.: 16/153,264

(22) Filed: Oct. 5, 2018

(30) Foreign Application Priority Data
Oct. 6, 2017 (EP) 17195222.9

(51) Int. Cl. A61H 1/00

(52) U.S. Cl. CPC A61H 1/005; A61H 2203/0456; A61H 1/006; A61H 1/003

(57) ABSTRACT

A support device, comprising a frame; a resting structure for a human body wherein the resting structure is pivotably attached at the frame and includes support elements configured to support a torso of the human body at the resting structure and a footrest; a pivot drive configured to pivot the resting structure at the frame about a transversal axis of the body between a prone position where a longitudinal axis of the body is parallel to a horizontal and a support position where the longitudinal axis of the body is inclined relative to the horizontal by a support angle wherein legs of the body support a weight of the body at least partially on the footrest; and an oscillation drive configured to induce an oscillation of the resting structure wherein the oscillation drive is supported at the frame and moves the resting structure parallel to the longitudinal axis.

### RELATED APPLICATIONS

This application claims priority from and incorporates by reference European patent application 17 195 222.9 filed on Oct. 6, 2017.

### FIELD OF THE INVENTION

The invention relates to a support device with a frame and with a resting structure for a human body that is pivotably attached at the frame, the resting structure comprising support elements for supporting a torso of the human body at the resting structure and a footrest, a pivot drive for pivoting the resting structure at the frame about a transversal axis of the body between a prone position where a longitudinal axis of the body is parallel to horizontal and a support position where the longitudinal axis of the body is inclined relative to horizontal by a support angle wherein legs of the body support a weight of the body at least partially on the footrest in the support position, and an oscillation drive for inducing an oscillation of the resting structure wherein the oscillation drive is supported at the frame and moves the resting structure parallel to the longitudinal axis. The invention also relates to a method for operating the support device.

### BACKGROUND OF THE INVENTION

Similar support devices without oscillating drive are being used to bring, e.g. paraplegic patients into an at least partially upright position in order to trigger a passive training stimulus by loading the bone skeleton along the longitudinal axis with the weight of the body. This so-called stand up training is intended to stimulate bone growth and increase bone density in order to counteract osteoporosis. Experiences with these passive support devices, however, have demonstrated that this passive form of standup training cannot generate a sufficient stimulus for bone growth.

U.S. Pat. No. 4,858,598 A discloses a generic type of the support device recited supra in which the resting structure is initially raised rhythmically by the oscillation drive by an eccentrical element, a pneumatic cylinder or an electromagnet and dropped after the eccentrical element has passed through or by disengaging the pneumatic control or turning off the electrical power supply in order to augment the stimulus in a manner that suffices for bone growth.

In the background of the invention threaded spindles are generally known which convert a rotating movement of a driven threaded rod into a linear movement of a spindle nut that is movable on the threaded rod in the longitudinal direction.

In the known support device the free drop of the resting structure terminates abruptly in the lower dead center of the oscillation. The legs of the patient are impacted in this moment by an impulse which is proportional to the weight and the square root of the stroke or drop elevation and which can cause trauma to the bone skeleton, in particular in an advanced stage of the osteoporosis. Measuring the dynamic load in the foot rest with strain gauges is very imprecise in particular in the critical moment when impacting the lower dead center as proposed in U.S. Pat. No. 4,858,598 A. Controlling a load on the patient through this measured oscillation is not possible in this manner.

### BRIEF SUMMARY OF THE INVENTION

Thus, it is an object of the invention to avoid an overload of the bone skeleton.

The object is achieved by A support device including a frame; a resting structure for a human body wherein the resting structure is pivotably attached at the frame and includes support elements configured to support a torso of the human body at the resting structure and a footrest; a pivot drive configured to pivot the resting structure at the frame about a transversal axis of the body between a prone position where a longitudinal axis of the body is parallel to a horizontal and a support position where the longitudinal axis of the body is inclined relative to the horizontal by a support angle wherein legs of the body support a weight of the body at least partially on the footrest; and an oscillation drive configured to induce an oscillation of the resting structure wherein the oscillation drive is supported at the frame and moves the resting structure parallel to the longitudinal axis, and wherein the oscillation drive excites the oscillation in both directions of the longitudinal axis by a threaded spindle in that a rotatable threaded rod of the threaded spindle moves a threaded nut that runs on the threaded rod.

The object is also achieved by a method for operating a support device including a frame and a resting structure for a human body wherein the resting structure is arranged at the frame, the method comprising the steps pivoting the resting structure about a transversal axis of the body at the frame so that a longitudinal axis of the body becomes inclined relative to a horizontal at a support angle and legs of the body support a weight of the body at least partially on a foot rest of the resting structure; and exciting the resting structure to oscillate parallel to the longitudinal axis, wherein the oscillation has a frequency of 1 to 2.4 Hz and a stroke of up to 25 mm.

Improving upon the known support device it is proposed according to the invention that the oscillating drive excites the oscillation in both directions of the longitudinal axis by a threaded spindle in that a rotatable threaded rod of the threaded spindle moves a threaded nut that runs on the threaded rod. The threaded spindle facilitates a gentle raising and in particular lowering with small, precisely controllable accelerations. Thus, the invention avoids the impulse that is generated in the known support device by the free drop of the foot rest and thus avoids the associated trauma risk.

The load amplitude can be adjusted on the one hand side by the support angle and on the other hand side by the amplitude of the oscillation.

Advantageously a support device according to the invention includes a pressure sensor at the foot rest that is configured to measure a pressure that is imparted by the legs parallel to the longitudinal axis upon the foot rest. The support device according to the invention thus facilitates a direct control of a load that is imparted upon the patient. In this support device the pressure sensor does not measure impulsive load changes but gentle load curves which facilitate a precise control, monitoring and documentation of the therapy.

Advantageously the pressure sensor in the support device according to the invention is a pressure sensitive mat. Pressure sensitive mats are commercially available in various configurations and facilitate the measurement without precise position of the legs.

Improving upon the known method it is proposed according to the invention that the vibration has a frequency of 1 to 2.4 Hz and a stroke of up to 25 mm. The method according to the invention can thus be practiced particularly well with a threaded spindle, thus with the support device according to the invention and is characterized by the advantages recited supra. The load impacting the bone skeleton of the patient according to the invention imitates a frequency and load distribution that is caused by slow walking.

Advantageously the oscillation according to the method according to the invention is periodic. Periodic oscillations with physiologically typical frequencies stimulate bone growth.

Advantageously the oscillation is controlled in a method according to the invention so that a pressure that is imparted by the legs parallel to the longitudinal axis upon the foot rest does not exceed a maximum value. A method of this type according to the invention avoids an excessive loading of the bone skeleton of the patient.

Advantageously measured values of the pressure according to the method according to the invention are stored and a maximum value is increased automatically.

Advantageously the method according to the invention automatically increases the stroke and/or the support angle. Methods according to the invention with an automatic increase of the maximum value, the stroke or of the support angle consider a training effect of the treatment with a support device that is operated according to the invention.

### BRIEF DESCRIPTION OF THE DRAWINGS

The invention is subsequently described based on an embodiment with reference to drawing figures, wherein;

FIG. 1 illustrates a device according to the invention in a support position;

FIG. 2A illustrates a perspective view of the support device according to FIG. 1,

FIG. 2B illustrates a detail of the support device according to FIG. 1, and,

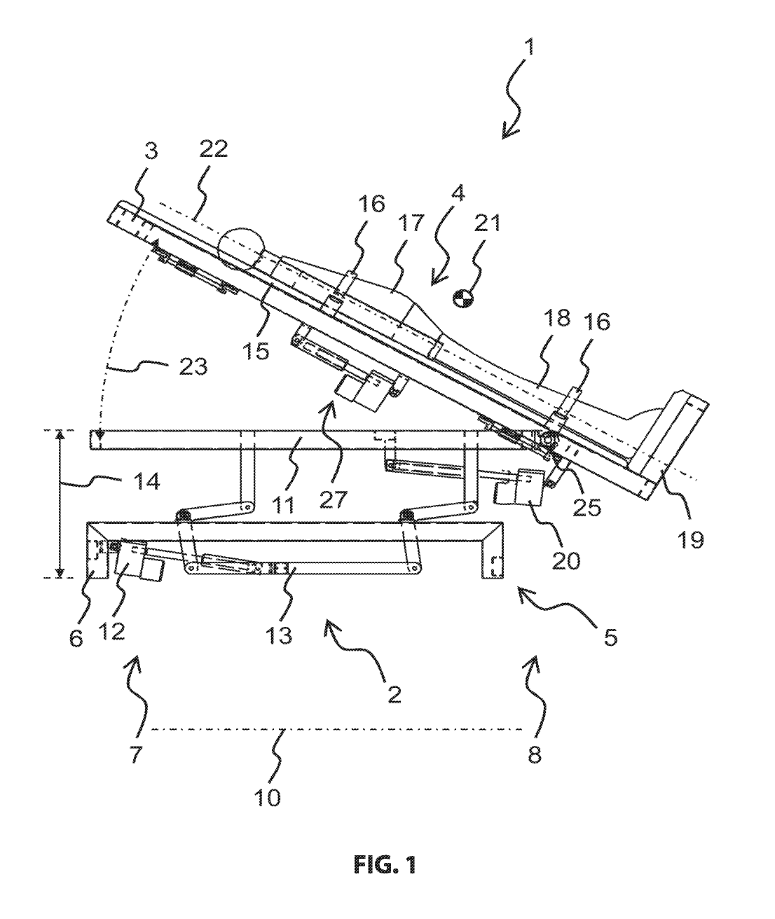

FIGS, 3A-C illustrate standard views of the support device according to FIG. 1 in another position.

### DETAILED DESCRIPTION OF THE INVENTION

The illustrated support device 1 according to the invention includes a frame 2 and a resting structure 3 for a human body 4 that is schematically illustrated in FIG. 1. The frame 2 is made for the most part from welded steel profiles, namely a pedestal 5 made from two U-shaped lobes 6 which are respectively connected by transversal beams 9 at a head end 7 and a foot end 8 of the support device 1, and a rectangular table 11 that is oriented parallel to a horizontal 10. The table 11 can be raised by a lift drive 12 through a level assembly 13 from the illustrated position with a table height 14 of 500 mm to a non-illustrated maximum operating height of 650 mm.

The resting structure 3 has a padded resting surface 15 and support elements 16 for supporting a torso 17 and legs 18 of the body 4. Belts can be used as support elements 16. Furthermore the resting structure 3 includes a padded foot rest 19 at the foot end 8.

The resting structure 3 is continuously pivotable by a pivot drive 20 about a transversal axis 21 of the body 4 from a non-illustrated prone position in which a longitudinal axis 22 of the body 4 is on the resting structure 3 which is on the table 11 and parallel to the horizontal direction 10 with respect to its support angle 23 between the longitudinal axis 22 and the horizontal 10 by an angle of up to 90 degrees.

The pivot drive 20 engages a frame 24 that is also welded from steel profiles and which is arranged in a joint 25 at the table 11. The resting structure 3 is movably supported on the frame 24 and supported in a direction of the longitudinal axis 22 by support bushings 26.

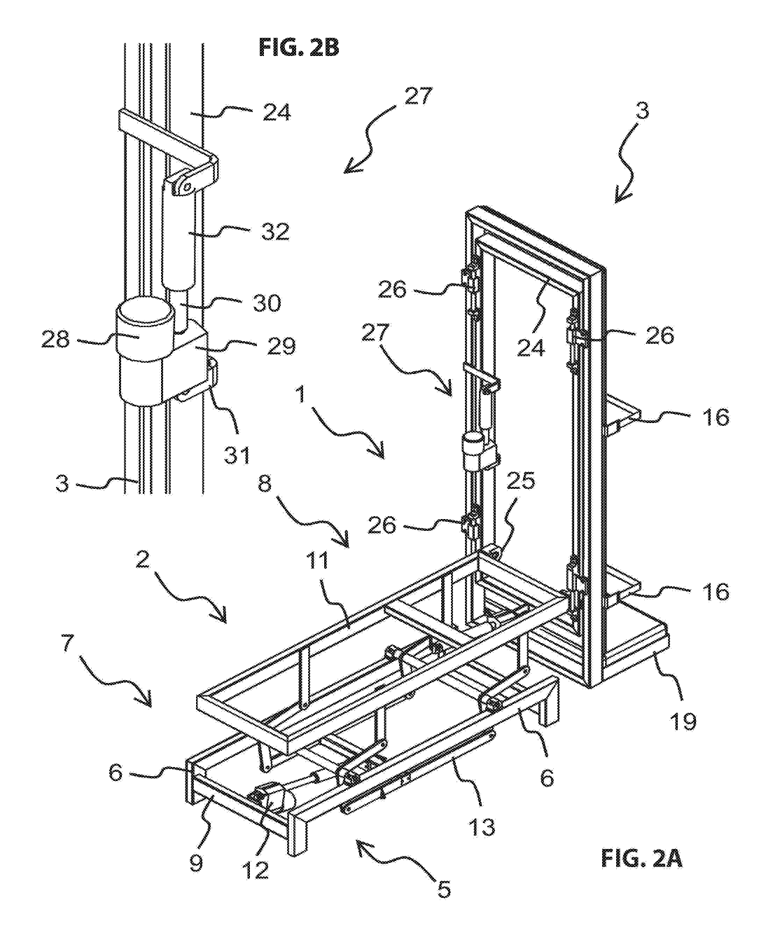

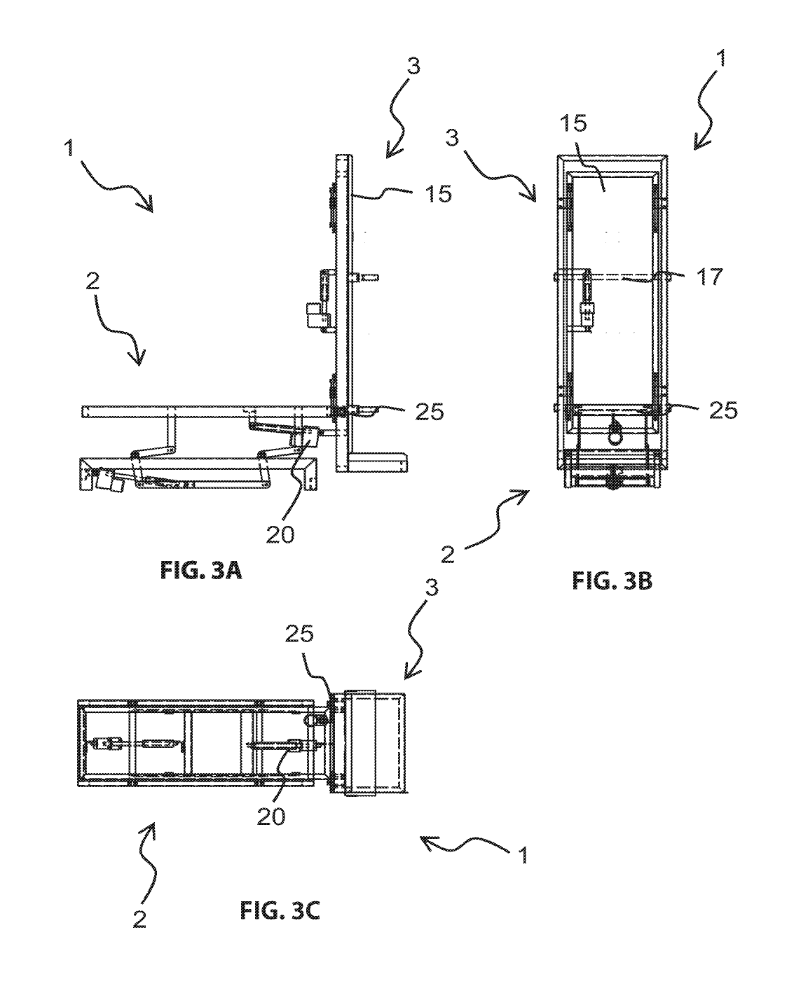

The support device 1 includes a pivot drive 27 that is illustrated in detail in FIG. 2B. The pivot drive 27 includes an electric motor 28 which drives a threaded rod 30 that extends in a direction of the longitudinal axis 22 through a transmission 29. The transmission 29 is attached in a support flange 31 at the frame 24. A threaded nut 32 runs on the threaded rod 30 and is connected with the resting structure 3.

When using the support device 1 for standup training the body 4 of the patient is initially placed on the resting surface 15 in the horizontal position so that the legs 18 are supported at the foot rest 19. Then the body 4 is fixed at the resting structure 3 by retaining elements 16 and the resting structure 3 is pivoted by the support angle 23.

In the pivoted position the resting structure 3 is induced to oscillate by the oscillation drive 27. By manually adapting frequency, amplitude and phase of the oscillation the support device 1 transfers a movement pattern which can corresponds for example to a memorized individual gait pattern to a bone skeleton of the patient. The treatment is repeated in uniform, e.g., daily intervals in order to provide a continuous exposure of the bone skeleton to gravitation stimuli, wherein the loading can be increased continuously as a function of improved bone load bearing capability indicators, e.g., bone density.

A height of the table 11, the support angle 23 of the resting structure 3, and the oscillation are adjusted by a non-illustrated control.

### REFERENCE NUMERALS AND DESIGNATIONS

1 Support device
2 Frame
3 Resting structure
4 Human body
5 Pedestal
6 Lobe
7 Head end
9 Foot end
9 Transversal beam
10 Horizontal
11 Table
12 Lift Drive
13 Lever assembly
14 Table elevation
15 Resting surface
16 Retaining element
17 Torso
18 Leg
19 Foot rest
20 Pivot drive
21 Transversal axis
22 Longitudinal axis
23 Support angle
24 Frame
25 Joint
26 Support bushing
27 Oscillation drive
28 Electric motor
29 Transmission
30 Threaded rod
31 Support flange
32 Threaded nut

What is claimed is:

1. A support device, comprising:
a frame;
a resting structure for a human body wherein the resting structure is pivotably attached at the frame and includes support elements configured to support a torso of the human body at the resting structure and a footrest;
a pivot drive configured to pivot the resting structure at the frame about a transversal axis of the body between a prone position where a longitudinal axis of the body is parallel to a horizontal and a support position where the longitudinal axis of the body is inclined relative to the horizontal by a support angle wherein legs of the body support a weight of the body at least partially on the footrest; and
an oscillation drive configured to induce an oscillation of the resting structure wherein the oscillation drive is supported at the frame and moves the resting structure parallel to the longitudinal axis, and
wherein the oscillation drive excites the oscillation in both directions of the longitudinal axis by a threaded spindle in that a rotatable threaded rod of the threaded spindle moves a threaded nut that runs on the threaded rod.

2. The support device 1 according to claim 1, further comprising a pressure sensor at the foot rest configured to measure a pressure that is imparted by the legs parallel to the longitudinal axis upon the foot rest.

3. The support device according to claim 1, wherein the pressure sensor is a pressure sensitive mat.

4. The support device according to claim 1, further comprising a lift drive configured to raise and lower the resting structure in a vertical direction.

5. A method for operating a support device including a frame and a resting structure for a human body wherein the resting structure is arranged at the frame, the method comprising the steps:
pivoting the resting structure about a transversal axis of the body at the frame so that a longitudinal axis of the body becomes inclined relative to a horizontal at a support angle and legs of the body support a weight of the body at least partially on a foot rest of the resting structure; and
exciting the resting structure to oscillate parallel to the longitudinal axis, wherein the oscillation has a frequency of 1 to 2.4 Hz and a stroke of up to 25 mm.

6. The method according to claim 5 wherein the oscillation is periodic.

7. The method according to claims 5, wherein the oscillation is controlled so that a pressure imparted by the legs parallel to the longitudinal axis upon the foot rest does not exceed a maximum value.

8. The method according to claim 7, wherein measured values of the pressure are stored, and the maximum value is increased automatically.

9. The method according to claim 5, wherein the stroke is increased automatically.

10. The method according to claim 5, wherein the support angle is increased automatically.
